(19) United States
(12) Patent Application Publication
(10) Pub. No.: US 2004/0037249 A1
(43) Pub. Date: Feb. 26, 2004

(54) Apparatus and method for determining soft handover in a CDMA mobile communication system

(75) Inventors: Chan-Byoung Chae, Songnam-shi (KR); Jae-Am Choi, Yongin-shi (KR); In-Bum Chang, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO. LTD., KYUNGKI-DO (KR)

(21) Appl. No.: 10/341,974

(22) Filed: Jan. 14, 2003

(30) Foreign Application Priority Data
Jan. 14, 2002 (KR) 1981/2002

(51) Int. Cl. H04Q 7/00

(52) U.S. Cl. 370/332; 370/335

(57) ABSTRACT

A soft handover apparatus and method in a CDMA mobile communication system are disclosed. According to the present invention, the step of comparing a predetermined threshold with the signal strength of a source Node B is further performed. If the signal strength is greater than the threshold and thus a handover required state is set, an assigned offset time is increased. No matter how strong signal is received from a target Node B, a soft handover procedure is performed only if the handover required state is maintained for the increased offset time.

### PRIORITY

This application claims priority to an application entitled “Apparatus and Method for Determining Soft Handover in a CDMA Mobile Communication System” filed in the Korean Industrial Property Office on Jan. 14, 2002 and assigned Serial No. 2002-1981, the contents of which are incorporated herein by reference.

### BACKGROUND OF THE INVENTION

1. Field of the Invention

The present invention relates generally to a soft handover method in a CDMA (Code Division Multiple Access) mobile communication system, and in particular, to an apparatus and method for implementing soft handover.

2. Description of the Related Art

In general, a CDMA communication system adopts a cell structure to support mobile service for many users with limited radio resources. An entire serviceable area is segmented into cells and the radio resources are assigned on a cell basis. A cell is defined as the service area of a Node B and each cell is identified by its corresponding Node B-specific scrambling code.

Even though a UE (User Equipment) moves from one cell to another cell, an ongoing service must continue without interruptions by handover. The handover is to change a communication path to a target Node B to thereby continue a call when the UE moves out of the service area of a source Node B and enters that of the target Node B. To determine availability of the handover, the UE measures the strengths of signals received from neighbor cells.

Handover is categorized into soft handover and hard handover. At the soft handover, the UE establishes a new channel with the target Node B with a channel connected to the source Node B and then releases one of both channels at a certain time. At the hard handover, the UE establishes a new channel with the target Node B after releasing a channel connected to the source Node B. The channel is, for example, a traffic channel.

While the soft handover improves service quality for the UE, it requires connection of channels to both the source and target Node Bs. The hard handover, despite bad service quality, saves radio resources. The CDMA mobile communication system supports the soft handover, whereas analog mobile communication systems and some digital mobile communication systems support the hard handover. Specifically, the hard handover occurs with different frequency allocations or between exchanges in the digital mobile communication systems and in a data service in an asynchronous mobile communication system. Herein, the soft handover will be dealt with.

FIG. 1 illustrates soft handover in a typical CDMA mobile communication system. Referring to FIG. 1, a UE 114 moves from the cell of a source Node B 110 to a handover region. In general, the UE 114 simultaneously receives signals from the source Node B 110 and a target Node B 112 being a neighbor cell. It determines whether a handover is required by comparing the received signal strengths of the source Node B 110 and the target Node B 112. When the UE 114 is located in the handover region, it measures the received signal strengths in FIG. 1, it can do so even when it is located in the cell of the source Node B 110. As the UE 114 enters the handover region and receives a signal having a desired strength from the target Node B 112, it transmits a Pilot Strength Measurement Message to the source Node B 110, requesting a handover. The source Node B 110 then reports the handover request to an RNC (Radio Network Controller: not shown) and the RNC performs a soft handover procedure for the UE 114 for a predetermined time. In the soft handover procedure, the RNC determines availability of the soft handover by considering preset conditions. If the soft handover is available, the RNC transmits a Handover Direction Message to the UE 114. A predetermined time later, the UE 114 transmits a Handover Completion Message in response for the Handover Direction Message to the RNC. Thus, a new channel established with the target Node B 112 is activated.

As described above, the UE 114 determines whether to implement a handover by comparing the received signal strengths of the source and target Node Bs 110 and 112.

FIGS. 2 and 3 are graphs illustrating soft handovers under an ideal radio channel environment in a conventional CDMA mobile communication system. With reference to FIG. 2, a description will be made of a conventional method of determining whether to implement a soft handover using a predetermined threshold.

Referring to FIG. 2, a UE measures the strength P_target of a pilot channel signal received from a target Node B during a service from a source Node B. The pilot channel usually delivers a pilot signal for checking the state of a radio channel. If the pilot strength P_target is greater than a threshold T_ADD, the UE transmits the pilot strength measurement to the source Node B by a predetermined message and then establishes a traffic channel with the target Node B.

After the traffic channel establishment, the UE measures the strength P_source of a traffic signal received from the source Node B. If the signal strength P_source is less than threshold T_DROP, the UE activates a Handover Drop timer to determine whether a predetermined drop time Δt has elapsed. The drop time Δt is provided from the source Node B by a measurement control message. If the signal strength P_source is below the threshold T_DROP for the drop time Δt, the UE releases the traffic channel from the source Node B. Thus, the UE receives a service from the target Node B.

In the above conventional soft handover method, whether to implement a handover is determined by comparing the received signal strengths of the source and target Node Bs with the two thresholds T_ADD and T_DROP, resulting in the increase of sensitivity to noise.

Another conventional soft handover method by comparing the received signal strengths of source and target Node Bs was proposed to solve the problem. This will be described with reference to FIG. 3.

Referring to FIG. 3, during a service from the source Node B, the UE measures the received signal strengths of the source and target Node Bs, P_source and P_target, and calculates the difference API between the signal strengths. The received signal strength P_target of the target Node B is the strength of its pilot signal. The UE compares the difference ΔP1 with a predetermined threshold (about 2 dB) with which to determine availability of the handover. If the difference ΔP1 is less than the threshold for the time Δt, the UE transmits the pilot strength measurement of the target Node B to the source Node B and then establishes a traffic channel with the target Node B.

After the traffic channel establishment, the UE measures the received signal strengths of the source and target Node Bs, P_source and P_target, and calculates the difference ΔP2 between the signal strengths. The UE compares the difference ΔP2 with another predetermined threshold (about 4 dB) with which to determine whether to release a traffic channel from the source Node B. If the difference ΔP2 is greater than the threshold for the time Δt, the UE releases the traffic channel from the source Node B and then receives a service from the target Node B. Here, the predetermined time Δt is provided from the source Node B.

While the above second conventional handover method is effective under an ideal or good radio channel environment, it may cause an unnecessary handover in an unstable propagation area such as a densely populated district.

FIG. 4 is a graph illustrating soft handover under an unstable radio channel environment in the conventional CDMA mobile communication system.

Referring to FIG. 4, it may occur that the difference API between the received signal strengths of the source and target Node Bs is less than the threshold, 2 dB as the radio channel environment of the target Node B gets better as indicated by reference numerals 410, 450, 420 and 430 and that of the source Node B gets worse as indicated by reference numeral 440. Situations indicated by reference numerals 410, 420, 430 and 450 may cause unnecessary handovers. In such situations, the UE may establish a traffic channel with the target Node B in a soft handover procedure. When the radio channel environment of the target Node B is stabilized, the traffic channel is released from the source Node B.

As described above, the convention soft handover method incurs unnecessary handovers in a densely populated district or under an unstable radio channel environment, resulting in the decrease of the capacity of the target Node B. Especially in an area having a very low probability of handover, unnecessary handovers may be generated due to exterior factors like buildings.

Since availability of soft handover is determined irrespective of propagation environment in the conventional CDMA mobile communication system, the efficiency of servicing a UE is decreased in a bad propagation environment.

### SUMMARY OF THE INVENTION

It is, therefore, an object of the present invention to provide an apparatus and method for preventing unnecessary occurrences of soft handover in a CDMA mobile communication system.

It is another object of the present invention to provide an apparatus and method for determining whether to implement soft handover in a CDMA mobile communication system.

It is a further object of the present invention to provide an apparatus and method for calculating a new offset time according to the difference between the received signal strengths of a source Node B and a target Node B.

To achieve the above and other objects, according to one aspect of the present invention, in a soft handover method based on signal strength in a CDMA mobile communication system, a UE compares the difference between the signal strengths of a source Node B and a target Node B measured at a predetermined time with a handover request offset. If the difference between the signal strengths of the source Node B and the target Node B satisfies the handover request offset, the UE adjusts an offset time assigned from the source Node B according to the difference between the signal strength of the source Node B and a predetermined threshold. If the soft handover request offset is satisfied for the adjusted offset time, the UE performs a soft handover procedure.

According to another aspect of the present invention, in a soft handover method based on signal strength in a CDMA mobile communication system, a UE compares the difference between the signal strengths of a source Node B and a target Node B measured at a predetermined time with a handover request offset. If the difference between the signal strengths of the source Node B and the target Node B is less than the handover request offset, the UE adjusts an offset time assigned from the source Node B according to the difference between the signal strength of the source Node B and a predetermined threshold. If the difference between the signal strengths of the source Node B and the target Node B is less than the handover request offset for the adjusted offset time, the UE performs a soft handover procedure.

According to a further aspect of the present invention, in a soft handover apparatus for a UE, a first finger receives a signal from a source Node B and measures the strength of the source Node B signal at a predetermined time. A second finger receives a signal from the target Node B and measures the strength of the target Node B signal at the predetermined time. A controller compares the difference between the signal strengths of the source Node B and the target Node B with a handover request offset, adjusts an offset time assigned from the source Node B according to the difference between the signal strength of the source Node B and a predetermined threshold if the difference between the signal strengths of the source Node B and the target Node B satisfies the handover request offset, and performs a soft handover procedure if the handover request offset is satisfied for the adjusted offset time.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates soft handover in a typical CDMA mobile communication system;

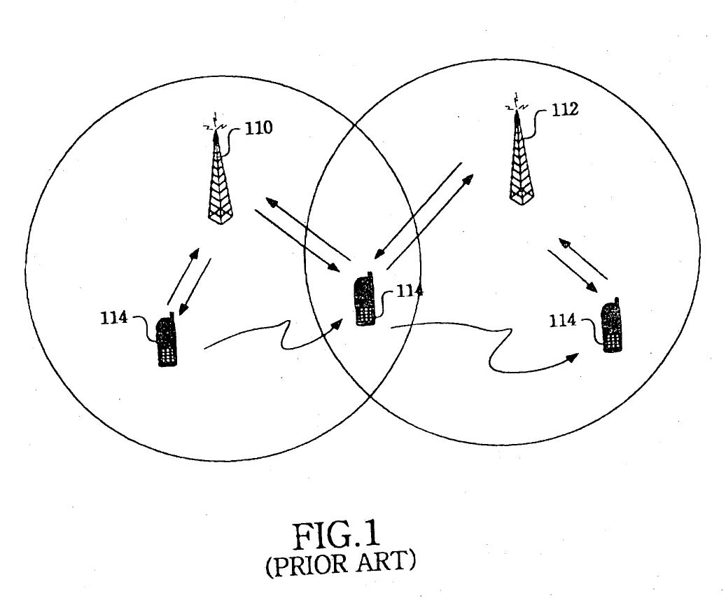

FIG. 2 is a graph illustrating a soft handover in a conventional CDMA mobile communication system;

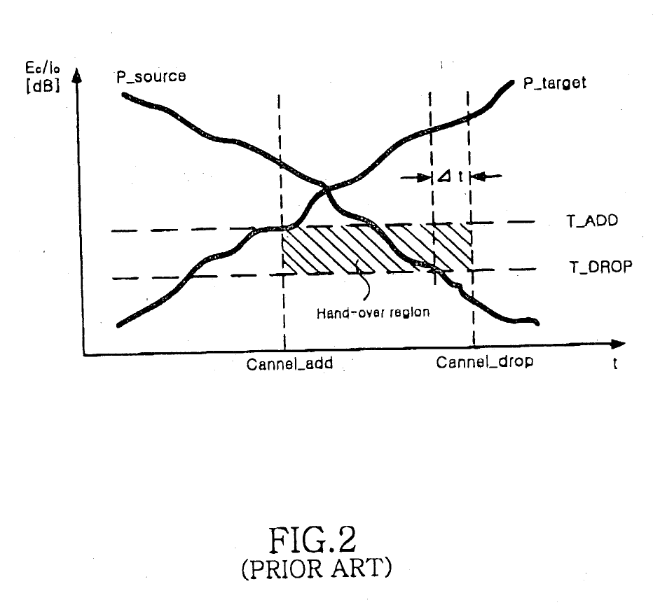

FIG. 3 is a graph illustrating another soft handover in the conventional CDMA mobile communication system;

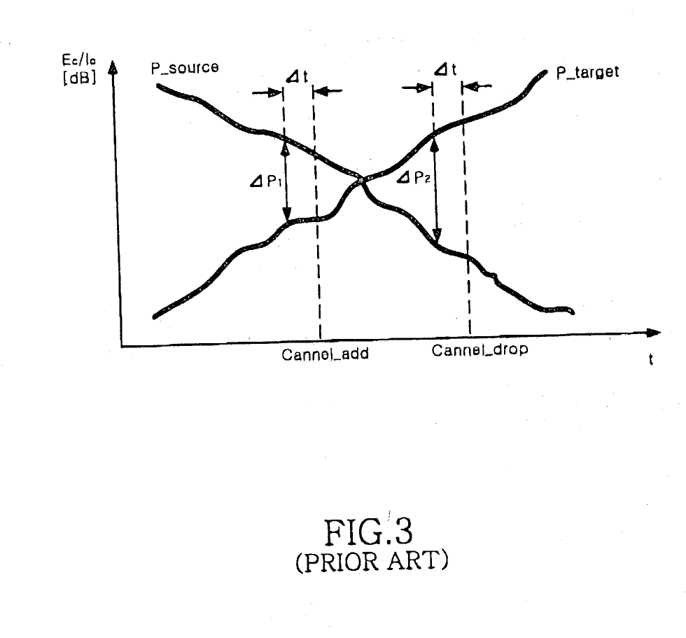

FIG. 4 is a graph illustrating soft handover under an unstable radio channel environment in the conventional CDMA mobile communication system;

FIG. 5 is a block diagram of a UE for determining availability of soft handover in a CDMA mobile communication system according to an embodiment of the present invention;

FIG. 6 is a flowchart illustrating a control operation in the UE for implementing soft handover in the CDMA mobile communication system according to an embodiment of the present invention;

FIG. 7 is a graph illustrating soft handover in the CDMA mobile communication system according to an embodiment of the present invention;

FIG. 8 is a graph illustrating soft handover under an unstable radio channel environment in the CDMA mobile communication system according to an embodiment of the present invention; and

FIG. 9 is a graph illustrating total Node B output power when a soft handover determining method is applied according to an embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

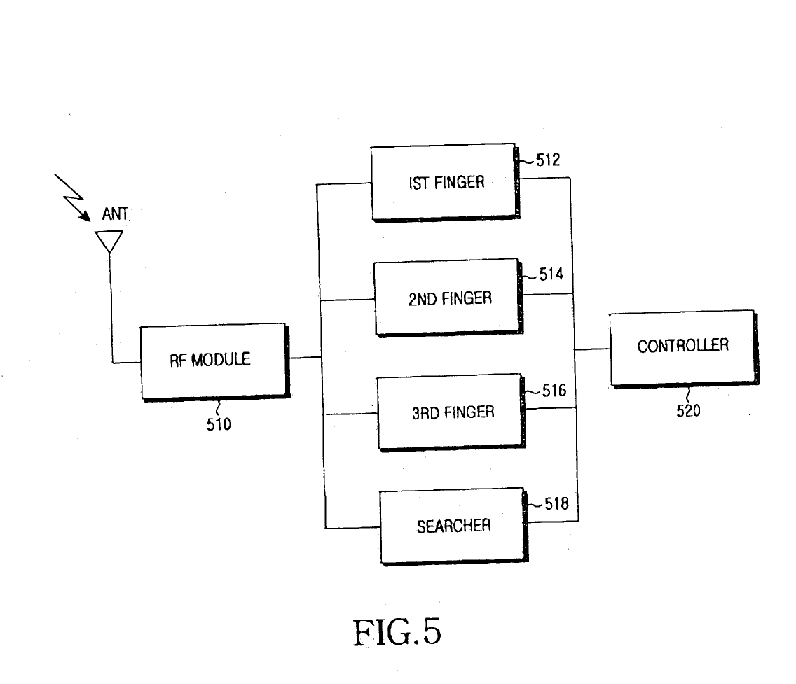

FIG. 5 is a block diagram of a UE for determining availability of soft handover in a CDMA mobile communication system according to an embodiment of the present invention.

Referring to FIG. 5, the UE receives signals from a source Node B and at least one target Node B through an antenna ANT. An RF (Radio Frequency) module 510 converts the received RF signals to IF (Intermediate Frequency) signals and feeds them to corresponding fingers 512-516 and a searcher 518. For example, a first finger 512 receives the signal from the source Node B, and second and third fingers 514 and 516 receive signals from different target Node Bs. The fingers 512, 154 and 516 measure the strengths of the input signals. A controller 520 performs a predetermined procedure for determining whether to implement a soft handover according to the signal strengths. The controller 520 also provides control to the UE in connection with the soft handover from the source Node B to a corresponding target Node B.

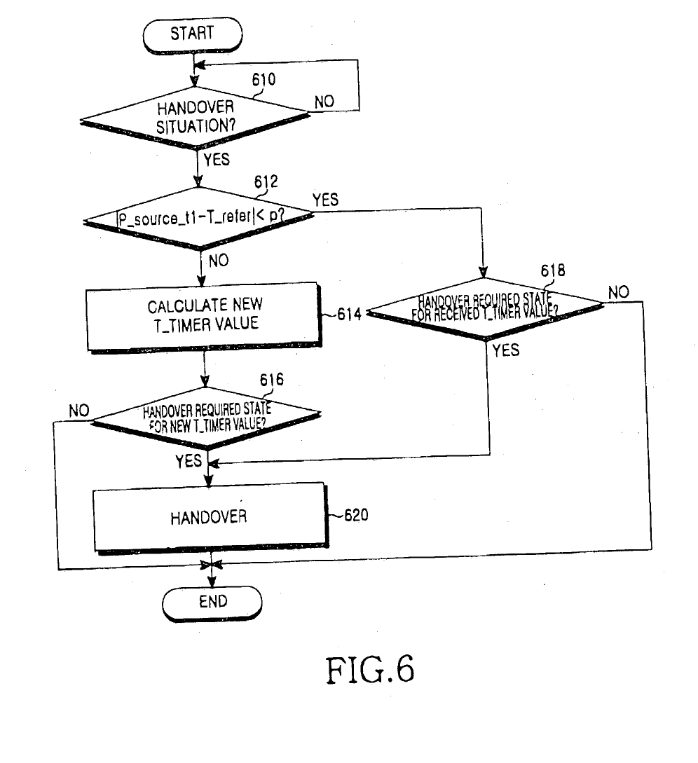

FIG. 6 is a flowchart illustrating a soft handover procedure in the UE in the CDMA mobile communication system according to an embodiment of the present invention.

During a service from a source Node B, the UE receives signals from the source Node B and at least one target Node B through the antenna ANT. The RF module 510 converts the received signals to IF signals and feed them to corresponding fingers. For example, the signal from the source Node B is fed to the first finger 512, and signals from different target Node Bs are fed to the second and third fingers 514 and 516. Thus, the first finger 512 measures the strength P_source of the source Node B signal, and the second or third finger 514 or 516 measures the strength P_target of the target Node B signal. The signal strengths P_source and P_target are SNRs (Signal-to-Noise Ratios) of the source and target Node Bs and are fed to the controller 520.

Referring to FIG. 6, the controller 520 determines whether a handover is to occur in step 610. That is, the controller 520 calculates the difference API between the received signal strengths P_source_t1 and P_target_t1 of the source Node B and the target Node B measured at time t1. If the difference ΔP1 is less than a predetermined handover request offset, the controller 520 determines that the handover is to occur.

If the handover is to occur, the controller 520 calculates the difference P_source_t1−T_refer between the source Node B signal strength P_source_t1 and a predetermined threshold T_refer and compares the absolute value of the difference P_source_t1−T_refer with a predetermined value P in step 612. The threshold T_refer can be a predetermined SNR indicating a signal strength required to provide a service. The value P is defined to be a margin above and below the threshold T_refer, set empirically such that a soft handover occurs in an appropriate situation. If the absolute value of the difference P_source_t1−T_refer is less than the value P, the controller 520 goes to step 618, and otherwise, it goes to step 614.

In step 618, the controller 520 determines whether the handover situation is maintained for a T_timer value Δt. The T_timer value Δt is an offset time provided from an RNC by a measurement control message. That is, if the absolute value of the difference P_source_t1−T_refer is less than the value P, the controller 520 uses the received timer value. If the handover situation is maintained for the T_timer value Δt, the controller 520 performs the handover in step 620.

On the other hand, if the absolute value of the difference P_source_t1−T_refer is equal to or greater than the value P, the controller 520 calculates a new T_timer value Δt+α in step 614. The value α is determined according to the absolute value of the difference P_source_t1−T_refer. Specifically, as the absolute value of the difference P_source_t1−T_refer increases, α is set to a greater value, and as the absolute value of the difference P_source_t1−T refer approximates to T_refer+p, α is set to a less value.

Determination of the value α according to the difference P_source_t1−T_refer will be described in more detail.

(1) When |P_source_t1−T_refer|<p (positive integer), Δt+α is equal to Δt;

(2) When P_source_t1−T_refer>q (positive integer), Δt+α is m×Δt (m>1);

(3) When p<P_source_t1−T_refer<q (positive integer), Δt+α is (P_source_t1−T_refer−T_refer+p)×m×Δt/q;

(4) When P_source_t1−T_refer<−q, Δt+α is Δt/p; and

(5) When −q<P_source_t1−T_refer<−p, Δt+α is (P_source_t1−T_refer−T_refer+p)×Δt/q/n. (herein, “q” is a positive integer smaller than p, and “m” and “n” are each an arbitrary positive integer.)

If many unnecessary handover occurrences are caused in a bad reception area, the T_timer value must be increased. On the other hand, the T_timer value must be decreased in an area where handover scarcely occurs. The increment and decrement must be set, for example, to a half of the received T_timer value, or less. In the above-described cases (1) and (2), the T_timer value can be increased by up to in times. In the cases (4) and (5), the T_timer value can be decreased by up to 1/n times. In a simulation according to the embodiment of the present invention, m is 2 and n is 2.

In the case (1), since P_source_t1 is between ±p, the assigned T_timer value is used. In the cases (2) and (3), P_source_t1 is equal to or greater than +p. Thus, the T_timer value is increased by up to m times. In the cases (4) and (5), since P_source_t1 is equal to or less than −p, the timer value is decreased by up to 1/n times.

After calculating the new T_timer value in step 614, the controller 520 determines whether a handover required state is maintained for the new T_timer value Δt+α in step 616.

If the handover situation is maintained for the new T_timer value Δt+α, the controller 520 performs the handover procedure in step 620. On the contrary, if the handover required state is not maintained, the handover is not performed.

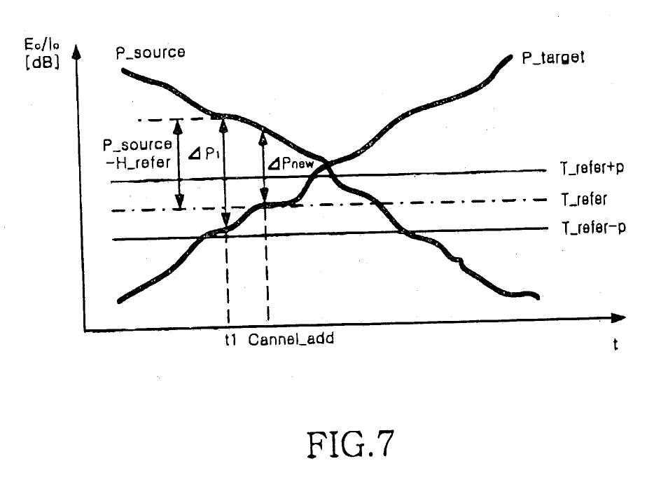

FIG. 7 illustrates soft handover in the CDMA mobile communication system according to the embodiment of the present invention.

Referring to FIG. 7, during a service from a source Node B, the UE measures the received signal strengths P_source and P_target of the source Node B and a target Node B. While it is assumed that the UE receives a signal from one target Node B in FIG. 7, the same thing is applied to signals from a plurality of target Node Bs. At time t1, the UE calculates the difference ΔP1 between the received signal strengths P_source_t1 and P_target_t1 of the source Node B and the target Node B and compares the difference ΔP1 with a predetermined threshold (about 2 dB). The threshold is an offset by which whether to implement a handover is determined. Such an offset is called “a handover request offset”. If the difference ΔP1 is less than the predetermined handover request offset, this is called a “handover required state”. In the handover required state, the UE calculates the difference P_source_t1−T_refer between the source Node B signal strength P_source_t1 and a predetermined threshold T_refer. If the difference P_source_t1−T_refer is equal to or greater than the sum of the threshold T_refer and the value P, the UE calculates a new offset time Δt+α. If the handover required state is maintained for the new offset time Δt+α, the UE performs a soft handover procedure.

As described above, the step of comparing the source Node B signal strength P_source with the threshold T_refer is further performed in the present invention. Thus, when P_source is greater than T_refer, no matter how strong signal is received from the target Node B, the handover procedure is performed only if the handover required state lasts for the new offset time. Here, the new offset time Δt+α is greater than the offset time Δt received from the RNC.

Though not shown in FIG. 7, in the case where the received signal strength P_target_t1 of the target Node B is too weak to perform a soft handover although P_source_t1 is less than T_refer, a new offset time Δt−α can be used. That is, the T_timer value can be increased by up to m times or decreased by up to 1/n times. The decrease of the timer value by up to 1/n times results in rapid transition of the target Node B from a neighbor cell to an active cell. Therefore, the diversity effect of weak signals from the source and target Node Bs in a handover region is achieved. Furthermore, a handover procedure is performed earlier on an unstable signal from the source Node B, to thereby receive a stable signal. The timer value Δt is an offset time provided from the RNC by a measurement control message, and the value α is determined according to the absolute value of the difference P_source_t1−T_refer.

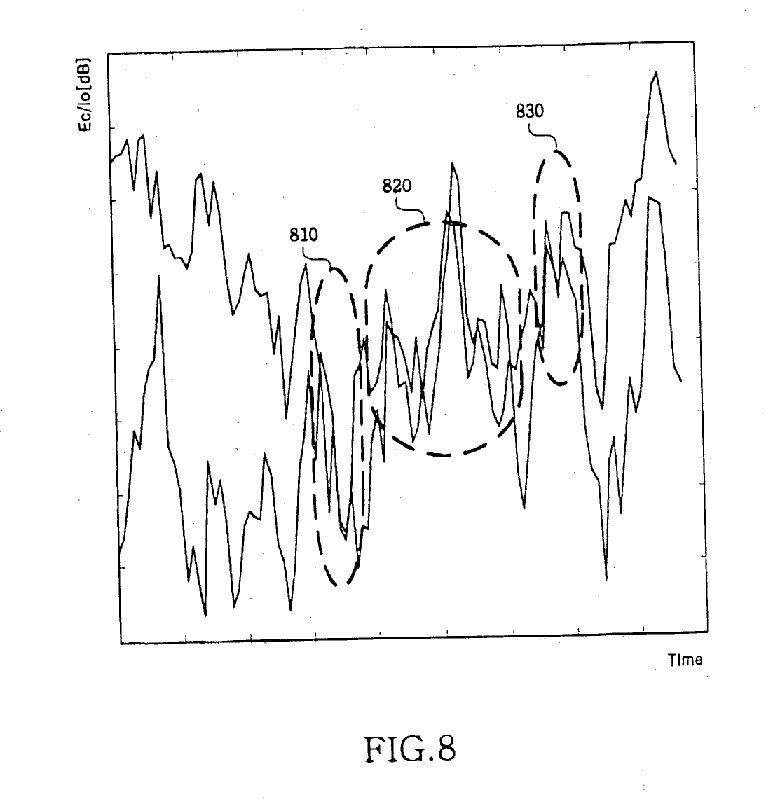

FIG. 8 is a graph illustrating soft handover under an unstable radio channel environment in the CDMA mobile communication system according to the embodiment of the present invention.

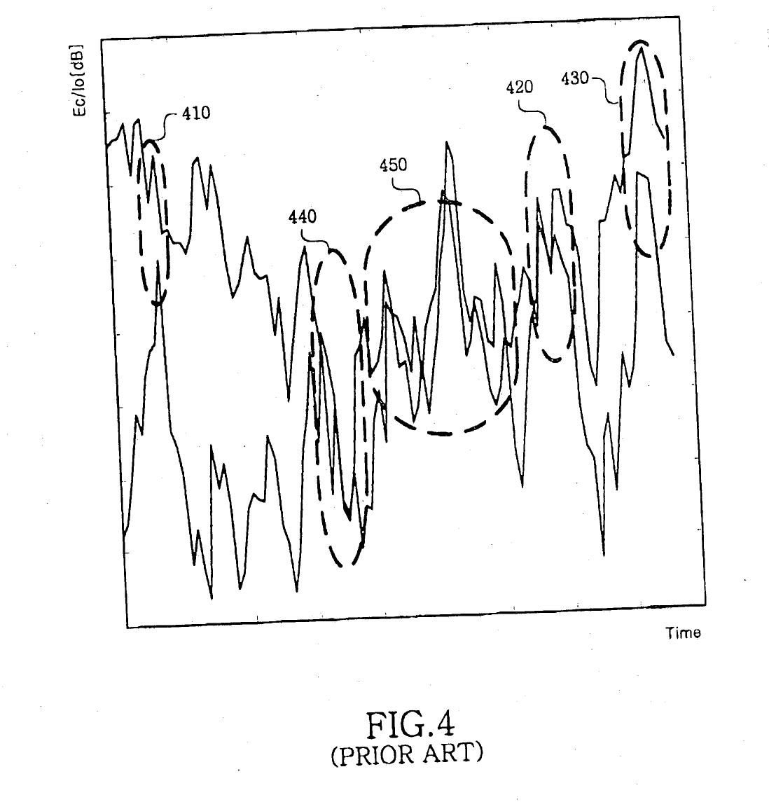

As noted from FIG. 8, soft handover does not occur in a handover situation caused by an unstable radio channel environment. The unnecessary handovers, as illustrated in FIG. 4, which occur in the conventional technology are prevented and only handovers 810, 820 and 830 occur according to the present invention in FIG. 8.

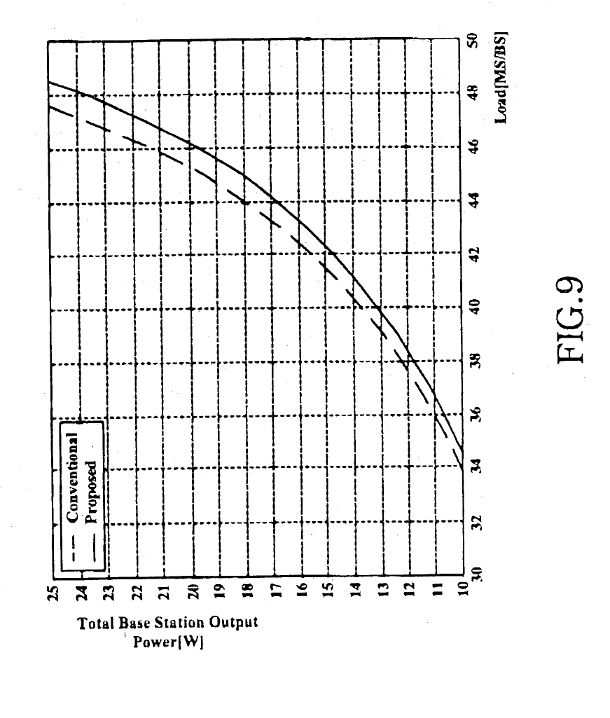

FIG. 9 is a graph illustrating a comparison in Node B output power (i.e., downlink capacity) between the conventional soft handover method and the soft handover method of the present invention. As illustrated in FIG. 9, a cell that accommodates up to 60 UEs experiences a 1 to 1.5 w power decrease in 75% of the UEs when it provides a voice service at 8 kbps.

In the embodiment of the present invention, establishment of a channel with the target Node B at a soft handover has been described. One of two channels connected to the source Node B and the target Node B must be released at an appropriate time. The channel release operation is performed in the order reverse to the new channel establishment operation. That is, when a channel is to be released in a good channel environment, a new T_timer value is set to be less than the received T_timer value. In a bad channel environment, the new T_timer value is set to be greater than the received T_timer value. The latter case corresponds to the afore-mentioned cases (4) and (5) and the former case corresponds to the cases (2) and (3).

In accordance with the present invention, the soft handover determination method prevents unnecessary handover occurrences encountered in a densely populated district such as downtown. Therefore, cell capacity is increased.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of determining in a UE (User Equipment) whether to implement a soft handover according to the strengths of a signal from a source Node B with a traffic channel connected to the UE and a signal from at least one target Node B in a CDMA (Code Division Multiple Access) mobile communication system, comprising the steps of:
comparing the difference between the signal strengths of the source Node B and the target Node B measured at a predetermined time with a handover request offset;
adjusting an offset time assigned from the source Node B according to the difference between the signal strength of the source Node B and a predetermined threshold, if the difference between the signal strengths of the source Node B and the target Node B satisfies the handover request offset; and
performing a soft handover procedure if the soft handover request offset is satisfied for the adjusted offset time.

2. The method of claim 1, wherein the soft handover request offset is satisfied if the difference between the signal strengths of the source Node B and the target Node B is less than the handover request offset.

3. The method of claim 1, wherein the offset time adjusting step comprises the steps of:
increasing the offset time if the difference between the signal strength of the source Node B and the threshold is increased; and
decreasing the offset time if the difference between the signal strength of the source Node B and the threshold is decreased.

4. The method of claim 1, wherein the offset time adjusting step comprises the steps of:
comparing the difference between the signal strength of the source Node B and the threshold with a predetermined offset value;
using the assigned offset time without adjustment if the difference between the signal strength of the source Node B and the threshold is less than the offset value; and
adjusting the assigned offset time according to the difference between the signal strength of the source Node B and the threshold if the difference between the signal strength of the source Node B and the threshold is equal to or greater than the offset value.

5. The method of claim 1, wherein the handover request offset is 2 dB.

6. A method of determining in a UE (User Equipment) whether to implement a soft handover according to the strengths of a signal from a source Node B with a traffic channel connected to the UE and a signal from at least one target Node B in a CDMA (Code Division Multiple Access) mobile communication system, comprising the steps of:
comparing the difference between the signal strengths of the source Node B and the target Node B measured at a predetermined time with a handover request offset;
adjusting an offset time assigned from the source Node B according to the difference between the signal strength of the source Node B and a predetermined threshold if the difference between the signal strengths of the source Node B and the target Node B is less than the handover request offset; and
performing a soft handover procedure if the difference between the signal strengths of the source Node B and the target Node B is less than the handover request offset for the adjusted offset time.

7. The method of claim 6, wherein the offset time adjusting step comprises the steps of:
increasing the offset time if the difference between the signal strength of the source Node B and the threshold; and
decreasing the offset time if the difference between the signal strength of the source Node B and the threshold is decreased.

8. The method of claim 6, wherein the offset time adjusting step comprises the steps of:
comparing the difference between the signal strength of the source Node B at the predetermined time and the threshold with a predetermined offset value;
using the assigned offset time without adjustment if the difference between the signal strength of the source Node B and the threshold is less than the offset value; and
adjusting the assigned offset time according to the difference between the signal strength of the source Node B and the threshold if the difference between the signal strength of the source Node B and the threshold is equal to or greater than the offset value.

9. An apparatus for determining in a UE (User Equipment) whether to implement a soft handover according to the strength of a signal from a source Node B with a traffic channel connected to the and the strength of a signal from at least one target Node B in a CDMA (Code Division Multiple Access) mobile communication system, comprising:
a first finger for receiving a signal from the source Node B and measuring the strength of the source Node B signal at a predetermined time;
a second finger for receiving a signal from the target Node B and measuring the strength of the target Node B signal at the predetermined time; and
a controller for comparing the difference between the signal strengths of the source Node B and the target Node B with a handover request offset, adjusting an offset time assigned from the source Node B according to the difference between the signal strength of the source Node B and a predetermined threshold if the difference between the signal strengths of the source Node B and the target Node B satisfies the handover request offset, and performing a soft handover procedure if the handover request offset is satisfied for the adjusted offset time.

10. The apparatus of claim 9, wherein the soft handover request offset is satisfied if the difference between the signal strengths of the source Node B and the target Node B is less than the handover request offset.

11. The apparatus of claim 9, wherein if the difference between the signal strength of the source Node B and the threshold is increased, the controller increases the offset time, and if the difference between the signal strength of the source Node B and the threshold is decreased, the controller decreases the offset time.

12. The apparatus of claim 9, wherein the controller compares the difference between the signal strength of the source Node B and the threshold with a predetermined offset value, uses the assigned offset time without adjustment if the difference between the signal strength of the source Node B and the threshold is less than the offset value, and adjusts the assigned offset time according to the difference between the signal strength of the source Node B and the threshold if the difference between the signal strength of the source Node B and the threshold is equal to or greater than the offset value.

13. The apparatus of claim 13, wherein the handover request offset is 2 dB.
